(19) United States
(12) Patent Application Publication
(10) Pub. No.: US 2019/0224825 A1
(43) Pub. Date: Jul. 25, 2019

(54) GAS SPRING AND IMPACTING AND DRIVING APPARATUS WITH GAS SPRING

(71) Applicant: Tricord Solutions, Inc., Franklin, TN (US)

(72) Inventors: Christopher Pedicini, Franklin, TN (US); John Witzigreuter, Canton, GA (US)

(21) Appl. No.: 16/168,827

(22) Filed: Oct. 24, 2018

Related U.S. Application Data
(60) Provisional application No. 62/621,044, filed on Jan. 24, 2018.

(51) Int. Cl. B25C 1/04; B25C 1/06

(52) U.S. Cl. CPC B25C 1/047; B25C 1/041; B25C 1/06

(57) ABSTRACT

A gas spring for an impacting device includes at least a cylinder, a piston, a seal, an and anvil for delivery of an impact. In an operational cycle, the piston may be moved to an energized position and thereafter released from the de-energized position. The gas pressure within the cylinder is preferably at least 200 psia. The cylinder may also include a safety valve rated to vent the cylinder pressure at a minimum of 150% of the original cylinder pressure. The piston volume may be less than 80% of the swept volume, and the piston may comprise a flange that has less than 90% of the cross sectional area of the cylinder. In an embodiment, the maximum kinetic energy of the piston never exceeds 30% of the cyclic potential energy of the gas spring.

### CROSS-REFERENCE TO RELATED APPLICATIONS

The present disclosure claims priority under 35 United States Code, Section 119 on the U.S. Provisional Patent Application, Ser. No. 62/621,044, filed on Jan. 24, 2018, the disclosure of which is incorporated by reference

### FIELD OF THE DISCLOSURE

The present disclosure relates to an electrically powered actuator for driving, impacting and other such apparatuses, and, more particularly, to a powerplant in the form of a gas spring which is used for actuation of a component of such apparatuses for driving fence posts, breaking concrete, setting rivets, driving nails, and otherwise performing multiple continuous impacts, as well as an apparatus with a gas spring.

### BACKGROUND

Impacting apparatuses (also referred to herein as a “driver,” “gun” or “device”) known in the art often may be configured for an entirely portable operation. Contractors commonly use power-assisted devices for impacting a surface and/or driving an object into a substrate. These power-assisted apparatuses can be portable (i.e., not connected or tethered to an air compressor or wall outlet) or non-portable.

A common source of energy for an impacting apparatus is wherein an air compressor, whereby compressed air is used to push an object into a substrate. For applications in which portability is not required, this is a very functional system and allows rapid delivery of fasteners for quick assembly. A disadvantage is that it does however require that the user purchase an air compressor and associated air-lines to use this system. A further disadvantage is the inconvenience of the device being tethered (through an air hose) to an air compressor.

To solve the problem of portability, several types of portable impacting devices operate off of fuel cells. Typically, these guns have a guide assembly in which a fuel is introduced along with oxygen from the air. The subsequent mixture is ignited with the resulting expansion of gases pushing the guide assembly and thus driving an object into a substrate. This design is complicated and expensive. Both electricity and fuel are required as the spark source derives its energy typically from batteries. The chambering of an explosive mixture of fuel, the use of consumable fuel cartridges, the loud report and the release of combustion products are all disadvantages of this solution. This further applies to those impacting devices which use a cartridge and a fastener in which the cartridge drives the fastener similar to the way it might launch a bullet.

Another solution is to use a flywheel mechanism and clutch the flywheel to an anvil that impacts a substrate. This tool is capable of impacting very quickly. The primary drawback to such a tool is the large weight and size as compared to pneumatic counterparts. Additionally, the drive mechanism is very complicated, which results in a high retail cost.

In yet another solution, a low pressure gas spring is used to actuate a fastener mechanism. Although this overcomes some of the complexity issues mentioned above, the configuration of the gas spring used in this product results in a large and cumbersome device. Specifically, this style tool (marketed as Senco Fusion or Hitachi Model NR1890) requires a safety mechanism as the anvil is under full power during the entire impact stroke. Additionally, the use of low pressure results in a much larger device which is counter to the overall objective of portability and compactness.

Clearly, and based on the above efforts, a need exists to provide portable solution for actuating apparatuses for impacting, driving, and the like, that is unencumbered by fuel cells or air hoses. Additionally, the solution ought to provide a low reactionary feel, and be simple, cost effective, compact, safe, and robust in operation.

The prior art teaches several additional ways of impacting. A first technique is based on a multiple impact design and a mechanical spring. In this design, a motor or other power source is connected to an impact anvil through either a lost motion coupling or other device. This allows the power source to make multiple impacts on an object to drive it into a substrate. However, the use of a mechanical spring increases the weight of the moving mass and hence the effective recoil of the tool after impact. Additionally, since the weight of the spring is significant, the efficiency is reduced as not all of the kinetic and potential energy in the mechanical spring is available to perform the impact.

A second design includes the use of potential energy storage mechanisms (in the form of a mechanical spring). In these designs, the spring is cocked (or activated) through an electric motor. Once the spring is sufficiently compressed, the energy is released from the spring into a striker, which striker then either impacts or drives a fastener. Several drawbacks exist to this design. These include size, weight and recoil. The energy density of mechanical springs is fairly low, thus to store sufficient energy, the spring must be very heavy and bulky. Additionally, the spring typically must operate near its limits to maximize performance, which can give shortened life from fatigue failure. Finally, metal springs must move a significant amount of mass in order to decompress, and the result is that these low-speed impacting devices result in a high reactionary force on the user and particularly reduced efficiency as in the aforementioned multiple impact device.

To improve upon this design, an air spring has been used to replace the mechanical spring, i.e., compressing air within a guide assembly and then releasing the compressed air by use of a drive. One common issue with both this design and the aforementioned spring design is the safety hazard in the event that the anvil jams on the downward stroke. If the operator thereafter tries to clear the jam, he is subject to the full force of the anvil, since the anvil is predisposed to the down position in all of these types of devices. This requires additional mechanisms to improve safety. A further disadvantage to the long stroke, low pressure air spring results from the need to have a ratcheting mechanism, which acts over the entire distance of the anvil drive. This mechanism adds weight and slows the drive stroke, thus increasing the reactionary force on the operator. Additionally, because significant kinetic energy is contained within the air spring and piston assembly the unit suffers from poor efficiency. This design is further subject to lower efficiency because of the low design pressure (initial pressure being less than 150 psi) which before our present disclosure was felt necessary to have sufficient life in the device.

A third means for impacting that is taught includes the use of flywheels as energy storage means. The flywheels are used to launch a hammering anvil that impacts a substrate. One major drawback to this design is the problem of coupling the flywheel to the driving anvil. This prior art teaches the use of a friction clutching mechanism that is both complicated, heavy and subject to wear. Further limiting this approach is the difficulty in controlling the energy—the mechanism requires enough energy to impact effectively, but retains significant energy in the flywheel after the drive is complete. This further increases the design complexity and size of such prior art devices.

All of the currently available devices suffer from one or more the following disadvantages:
Complex, expensive and unreliable designs.
Consumable fuels, combustion products, expensive to operate.
Rotating flywheel designs have complicated coupling or clutching mechanisms based on frictional means. This adds to their expense.
Poor ergonomics. The fuel powered mechanisms have loud combustion reports and combustion fumes. The multiple impact devices are fatiguing and are noisy.
Non-portability. Traditional impacting devices are tethered to a fixed compressor and thus must maintain a separate supply line.
High reaction force and short life. Mechanical spring driven mechanisms have high tool reaction forces because of their long drive times. Additionally, the springs are not rated for these types of duty cycles leading to premature failure.
Safety issues. The prior art “air spring” and heavy spring driven designs suffer from safety issues for impacting since the predisposition of the anvil is towards the substrate. During jam clearing, this can cause the anvil to strike the operator's hand.
Size related to low pressure/long stroke springs.

In light of these various disadvantages, there exists the need for an impactor apparatus that overcomes these various disadvantages of the prior art, while still retaining the benefits of the prior art. It is believed that such an apparatus will require a different impact force generating element than has been previously disclosed or used.

### SUMMARY OF THE DISCLOSURE

In accordance with the present disclosure, a gas spring (also referred to herein as an actuator) for a driving, impacting or other apparatus is provided. In another embodiment, an apparatus with a gas spring is provided. The apparatus may be powered by an electrical source, preferably rechargeable batteries, and have the actuator selectively energized by a motor. The actuator comprises a gas spring, and the gas spring may be coupled to an impacter, anvil, striker or other impacting or driving element.

In an embodiment, the gas spring (or apparatus comprising the gas spring) includes a one-way piston seal in which the gas spring can be charged by having the external pressure around the piston seal exceed the internal pressure of the gas spring. This allows for elimination of a separate charging port and simplifies the design of the apparatus. An indicator may be provided on the gas spring or apparatus to display the state and/or extent of charge of the gas spring. The gas spring may comprise a chamber (also referred to herein as a cylinder) and a piston that is at least partially disposable within the chamber. In an embodiment, the displacement of the piston within the chamber may be used to alternatively increase the potential energy stored in and released from the gas spring. In an embodiment, the displacement of the piston is less than the displacement of the anvil.

In an embodiment, the gas spring of the present disclosure comprises a lightened piston. In a further embodiment the piston has part of its internal core removed. In a further embodiment, the piston has a swept volume that is at least 20% greater than the actual) volume of the piston. (As used herein, “swept volume” is the volume displaced within the chamber during movement of the piston within the chamber).

The gas spring may further comprise a bumper, which bumper may absorb energy of the piston, such as impact of the piston as it moves from an energized to a de-energized position. In an embodiment, the bumper may be comprised of an elastomer which has a strain of at least 10% during the impact of the piston upon the bumper within the gas spring. In an embodiment the bumper may be within the chamber of the gas spring. In an embodiment, the gas spring may comprise at least two seals and a vented reservoir between said at least two seals.

In an embodiment, the stroke of the gas spring is preferably less than the stroke of the impacter, anvil, striker, etc. of the apparatus that comprises the gas spring. Preferably, the gas spring has a minimum internal pressure of at least 200 pounds per square inch (psi). In embodiment, the gas or gas mixture that charges the gas spring comprises at least 95% of a nonreactive gas (such as nitrogen), halocarbon or a noble gas. In a further embodiment, the piston seal has a permeability that is higher for oxygen than it is for the nonreactive gas, which extends the pressurized life of the gas spring.

The piston of the gas spring may comprise aluminum or magnesium or a lightweight composite with a density of less than 0.1 pound per inch³. The piston may have a coating of at least one of Teflon, electroless nickel, hard anodized, hard chrome, or a combination of the above. The piston may be configured to have a sliding coefficient of friction that is less than 0.3 as it moves from an energized or de-energized position.

By using the improved gas spring disclosed herein, an apparatus comprising the present gas spring is able to generate sufficient energy to impact a substrate and/or drive an object in both a space efficient and energy-efficient manner.

Accordingly, and in addition to the objects and advantages of the portable impacting apparatus as described above, several objects and advantages of the present disclosure are:
To provide a simple design for impacting, driving which has an improved safety profile over other stored energy devices
To provide a simple design for impacting, driving, and other such apparatuses that has a significantly lower production cost than currently available devices and that is portable and does not require an air compressor.
To provide an impacting, driving, and other such apparatuses that mimics the pneumatic fastener performance without need for a tethered air compressor.
To provide an electrically driven high-powered impacting, driving or other such apparatus that is compact and has a long life.
To provide a more energy-efficient mechanism for driving objects and impacting substrates than is presently achievable with an on-demand compressed air design.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present disclosure will become better understood with reference to the following detailed description and claims taken in conjunction with the accompanying drawings, wherein like elements are identified with symbols, and in which:

FIG. 1 shows a gas spring, in accordance with an exemplary embodiment of the present disclosure;

FIG. 1A shows a cutaway view of a gas spring, in accordance with an exemplary embodiment of the present disclosure;

FIG. 2 shows an overpressure chamber in communication with a gas spring, in accordance with an exemplary embodiment of the present disclosure;

FIG. 3 shows an apparatus incorporating a gas spring, in accordance with an exemplary embodiment of the present disclosure;

FIG. 3a shows an apparatus incorporating a gas spring in accordance with an exemplary embodiment of the present disclosure;

FIG. 4 shows a gas spring and anvil, in accordance with an exemplary embodiment of the present disclosure;

FIG. 5 shows a gas spring and anvil, in accordance with an exemplary embodiment of the present disclosure;

FIG. 6 shows a gas spring, in accordance with an exemplary embodiment of the present disclosure;

FIG. 7 shows a cutaway view of a gas spring, in accordance with an exemplary embodiment of the present disclosure; and

FIG. 8 shows an alternate embodiment of an impacting mechanism incorporating a gas spring in accordance with an exemplary embodiment of the present disclosure.

### DETAILED DESCRIPTION OF THE DISCLOSURE

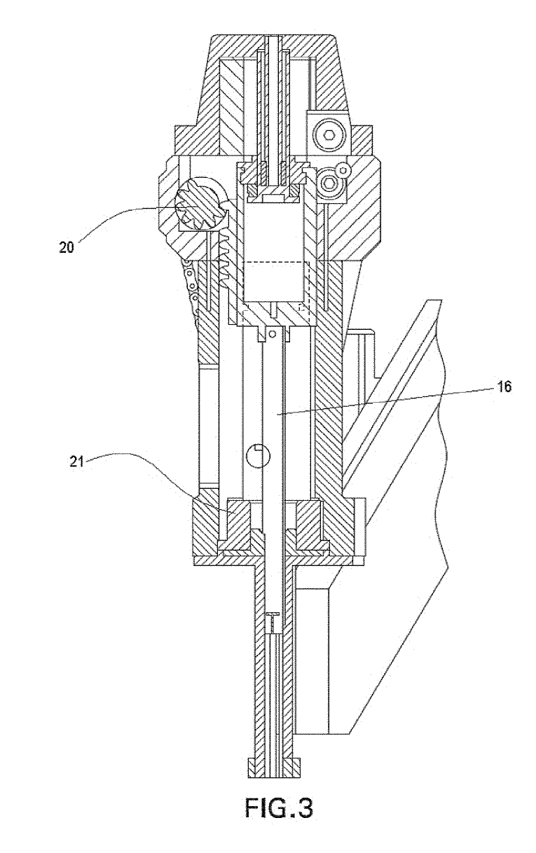

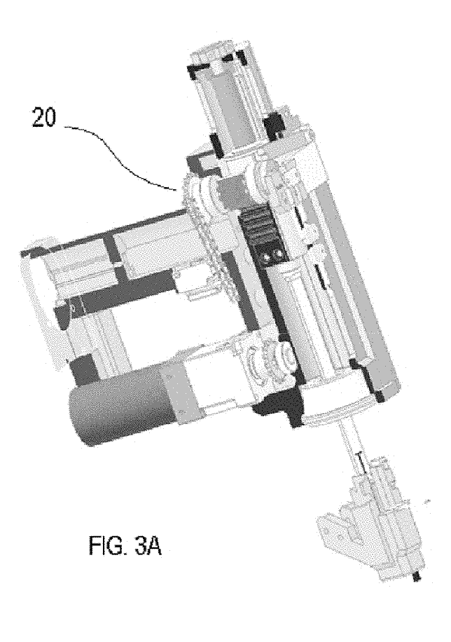

The best mode for carrying out the present disclosure is presented in terms of its preferred embodiment, herein depicted in the accompanying figures. Included in the embodiment is an illustration (FIG. 3) of the present disclosure in a fastener driving apparatus. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure. Furthermore, although the following relates substantially to one embodiment of the design, it will be understood by those familiar with the art that changes to materials, part descriptions and geometries can be made without departing from the spirit of the disclosure. It is further understood that references such as front, back, or top dead center, bottom dead center do not refer to exact positions but approximate positions as understood in the context of the geometry in the attached figures.

The terms “a” and “an” herein do not denote a limitation of quantity, but rather denote the presence of at least one of the referenced items.

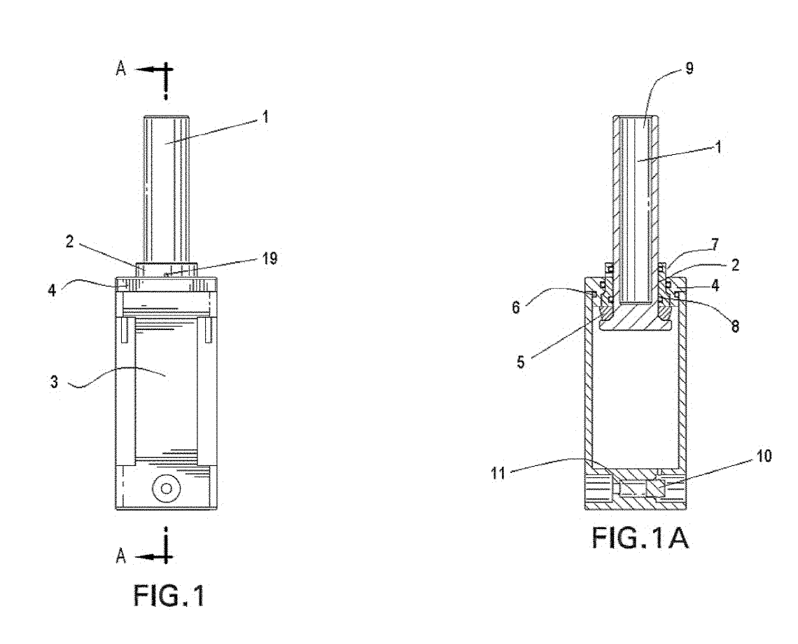

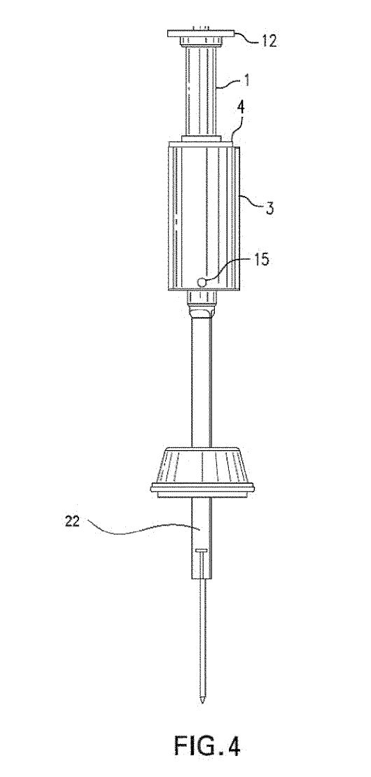

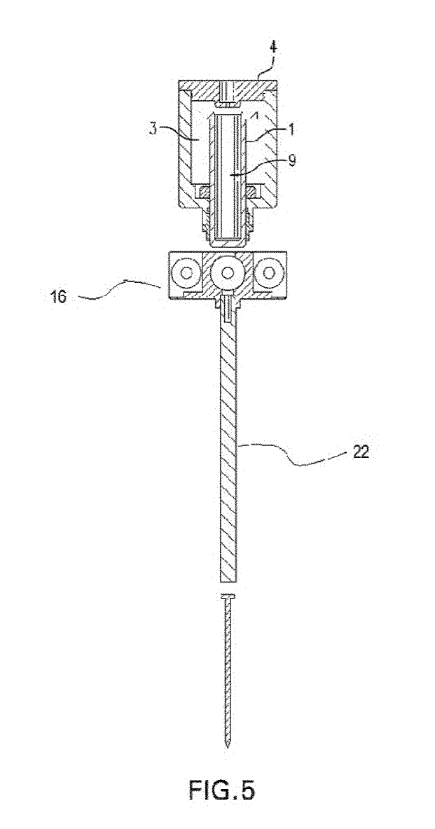

Referring to the figures, and in accordance with the present disclosure, a gas spring 100 for providing an impact to an object such as a fastener, and for an impacting or driving device (such device referred to herein as “impacting device”) is provided as shown in exemplary embodiments in FIGS. 1 and 5. An alternative embodiment of a gas spring used to create an impact is shown in FIG. 5, and it should be understood these depictions are not to be construed as limiting. An exemplary gas spring impacting apparatus that incorporates gas spring 100 is shown in FIG. 3 and may be powered by an electrical source, preferably rechargeable batteries, and has an operative coupling 20 (such as a linear motion converter or rack and pinion arrangement) between a motor and the gas spring for alternatively energizing and allowing the gas spring to de-energize. For the purpose of this disclosure, energizing the gas spring refers to increasing the potential energy stored in the gas spring. As shown in FIG. 4, the gas spring 100 may be coupled to an anvil 22 or other impacting or driving element for the purpose of delivering a portion of the potential energy in the gas spring to a fastener or other impacted object. In an embodiment, an anvil may include other elements for operative connections, guiding, and the like, which other elements may be part of an assembly or anvil assembly as shown in FIG. 5. For purposes of this disclosure, the terms anvil, anvil assembly and striker can be used interchangeably without departing from the spirit of the invention. In FIGS. 1, 3 and 4, the apparatus comprises a power source, a motor, a control circuit, a drive mechanism, the gas spring as disclosed herein, an anvil 22, and at least one bumper 5 for absorbing excess energy. The gas spring 100 includes a piston 1 that is at least partially disposed within a cylinder or chamber.

It was discovered in this disclosure that the gas spring 100 could be cycled at pressures far in excess of typical pneumatic impactors (as will be discussed further elsewhere herein). This unexpected discovery allowed for a reduction in the size of the apparatus that incorporates gas spring 100 and an increase in efficiency as the piston could be made much smaller than is typically found in existing pneumatic impactors. In an embodiment, the gas pressure in the cylinder is a minimum of 200 psi, allowing a 50% reduction in the piston diameter and, consequently, the chamber volume. It will be apparent that the term “cylinder” is used to define a partial enclosure and is not limited to being of a circular nature. The alternative term (“chamber”) used herein refers to the space that the gas may occupy inside the cylinder and is also not limited to a particular geometry.

A bushing 2 may be disposed on the exterior of the cylinder 3 (preferably, at the cylinder end cap 4 of the cylinder), which bushing 2 facilitates securing and guiding a portion of the piston 1 within the cylinder 3 while still allowing movement of the piston 3. It should be recognized that the bushing 2 can be combined or integrated with the end cap 4 as a single element within the design as shown in FIG. 3 for example.

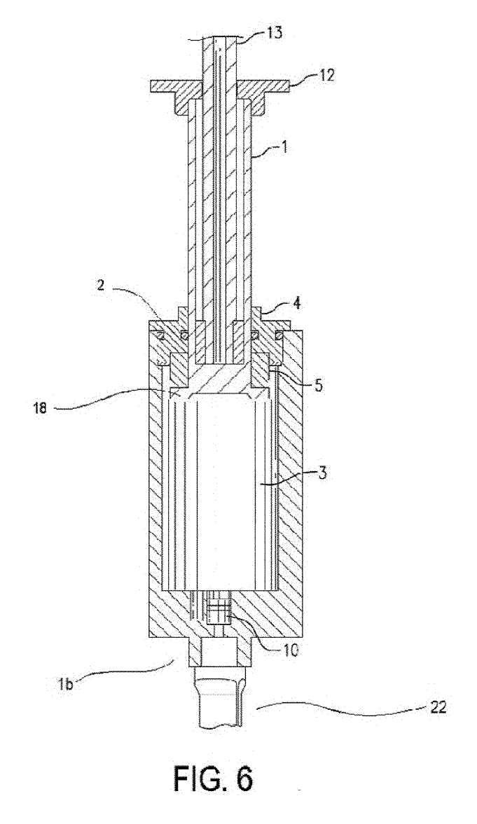

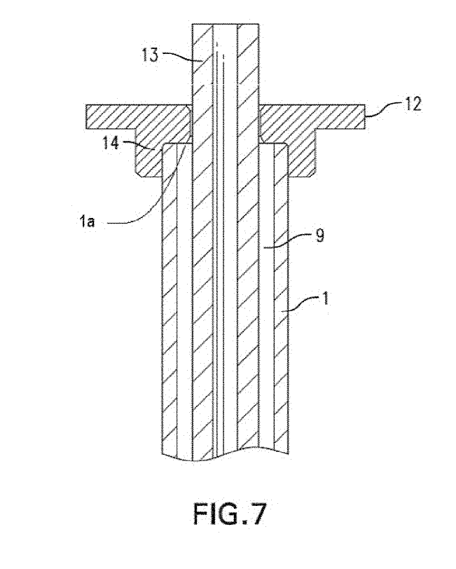

In a further embodiment (as shown in FIGS. 1A, 3, 5 and 6) a bumper 5 absorbs a portion of the force of impact of the piston 1 at one portion of the stroke. It is preferred that the bumper 5 be located within the gas spring 100, and more particularly, within the cylinder 3 of the gas spring 100. The gas spring 100 may further comprise a nose portion 1a (shown in an exemplary embodiment in FIG. 7, which nose portion 1a may be a part of or coupled to the piston) and which nose portion 1a may make operative contact with a pusher plate 12 of an apparatus during a portion of the operating cycle of the apparatus. In a still further embodiment (as shown in FIGS. 6 and 7), at least a portion of the nose portion 1a may engage a retaining element (which may be proximate to the bumper) in order to enable a positive retention of the gas spring 100 and/or anvil 22 at a point in the cycle. Such retaining element 14 (which may be part of the pusher plate 12) and piston nose portion 1a each have at least a section with a taper of less than 10 degrees such that upon mating of the two surfaces the anvil is retained in a first position. Preferably the mating surfaces have tapers less than 7 degrees to form a locking fit.

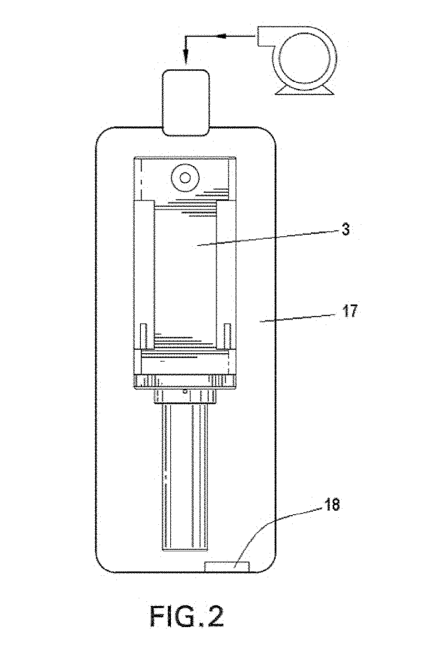

In an embodiment, and as shown in FIGS. 1A, 2 and 6, the gas spring 100 can be further or initially pressurized by incorporating one or more one-way seals in the gas spring 100. Such seals may include cup seals or valve spools 10 that operate on a differential pressure. The difference between the supplied pressure (such as pressure from an overpressure chamber 17, as shown in FIG. 2 that is in fluidic communication with gas spring 100) and the pressure inside the gas spring 100 causes the pressure in the gas spring chamber 30 to increase. Upon removal of the external or supplied pressure, the one way valve shuts, trapping the high pressure gas inside the gas spring chamber 30. In an embodiment, a pneumatic cup or lip seal may serve as both the seal and one way valve for example.

In another embodiment, the gas or gas mixture that charges the gas spring 100 comprises at least 80% of an unreactive gas such as nitrogen or argon. It was unexpectedly discovered that the use of nitrogen or, more preferably, argon, enables the gas spring to stay at a high pressure for a much longer period of time. In addition, the use of unreactive gasses prevents oxidation of internal lubricants and/or other organic compounds that are present inside the gas spring chamber 3 during operation.

In an embodiment, the movement of piston 1 of the gas spring is used to alternatively add and release energy of the gas spring 100. In an embodiment, the gas spring of the present disclosure comprises a lightened piston 1 in which a portion 9 of the piston has been removed to reduce weight. In a further embodiment, the piston volume is reduced at least 20% from the volume which would otherwise be present if the piston were not hollowed or cored out. (The volume of the piston 1 which has not been lightened by material removal is referred to herein as the solid volume of the piston.) It was discovered in the course of the disclosure that for high speed impacting or fastening, that the mass of the piston 1 needed to be minimized in order to have an acceptable useful life of the bumper 5. In a further embodiment and to increase life of the gas spring, the piston 1 of the gas spring 100 may comprise aluminum, magnesium, composite plastic, fiber reinforced resin or other lightweight material having a density of less than 0.1 pound per cubic inch in order to provide acceptable useful life.

In a further embodiment, the piston 1 may have a coating of at least one of Teflon, electroless nickel, hard anodization, and hard chrome. The piston 1 may be configured to have a coefficient of friction that is less than 0.3. In another embodiment, the piston 1 has a flange 18 (shown in FIG. 6) which flange has a cross-sectional area of no more than 90% of the cross-sectional area of the air chamber 30. It was unexpectedly discovered in the course of this disclosure that when the area exceeded this threshold that throttling of the air as it moved past the flange 18 within the air chamber 30 reduced the efficiency of the device.

In an embodiment and as shown in FIGS. 1 and 1A, the gas spring 100 may comprise at least two seals 7 and 8 and a vented reservoir 19 between said at least two seals (with the vent comprising, in an embodiment, an o-ring chamber seal 6). In a preferred embodiment, the seals are disposed within the bushing 2 of the gas spring 100, with at least one seal 8 on or operatively proximate to a high-pressure side of the cylinder and at least one seal 7 on or operatively proximate to a low-pressure side of the cylinder. The reservoir 19 may further be charged with a lubricant such as Parker Super Lube™ or the like for the purpose of keeping the seals lubricated during operation. A lubricant may also be provided in the gas spring chamber 30. The low-pressure side seal 7 may comprise or function as a scraper for reducing or preventing debris from coming into contact with the seal 8 on the high-pressure side of the bushing. In an embodiment, the high-pressure side seal 8 comprises a piston o-ring chamber seal or other pneumatic seal. In such a configuration as elsewhere, a vent 6 may be provided for venting the reservoir 19 that is disposed between the piston high pressure seal and the o-ring scraper.

In an embodiment, the stroke of the gas spring piston 1 is preferably less than the stroke of the impacter, anvil, striker, etc. of the apparatus that comprises the gas spring.

In an embodiment, the gas spring 100 may further comprise an elastomer 13 or other element for the purpose of resetting the anvil 22 to a first position after the gas spring 100 has released at least a portion of the potential energy that has accumulated within the gas spring 100.

A drive mechanism 20 (shown in FIG. 3A, for example) engages and disengages the gas spring 100 to increase the potential energy within the gas spring 100 (i.e., to energize the gas spring 100). The gas spring 100 may typically be energized by the drive mechanism 20 in 100-300 milliseconds, and the energy may be released in around 5 milliseconds. The gas spring 100 can be used to drive a striker or an anvil separately for at least a portion of the operational cycle of an apparatus.) It is further preferable in certain cases that the gas spring and anvil comprise an assembly that moves cooperatively during the operational cycle of the apparatus.

When energy is released from the gas spring 100 it must either go into the item that is being driven (i.e. anvil, nail, or post for example), or be absorbed by an external bumper 21. In the case of a dry fire of the apparatus (operating the apparatus without impacting or driving an object) the gas spring bumper 21 is preferably configured so that it can absorb all of the gas spring energy that is released. As an illustrative example, such bumper 21 maybe made of urethane with an outside diameter of 1.500 inches and an inside diameter of 0.63 inches and a 1.3 inch thickness.

A configuration of an anvil 22 (or impacter, drive blade or striker, all of which are collectively referred to as “anvil” herein) and fastener (or other object to be driven) is also provided herein. In an embodiment (and as shown in exemplary form in FIGS. 3 and 4), prior to compression of the gas spring, the end of the anvil that is proximate to a to-be-driven fastener overlaps a portion of the fastener that is in position to be driven by the anvil. Preferably, the amount of overlap is between 0.010 and 0.50 inches. Such overlap provides for an unexpected advantage in at least two ways. First, upon resetting of the gas spring 100 to an initial position, there is inevitably some bounce or rebound associated with the return. By providing an overlap, the bounce/rebound that occurs reduces the opportunity for dislodging of other fasteners from a collation or other loading area. The overlap reduces or prevents the anvil end that is distal to the fastener from rebounding, which bouncing or rebounding could otherwise dislodge another fastener from the collation. It was further unexpectedly discovered that the use of a low rebound polyurethane for bumper 21 (low rebound being having a coefficient of restitution (cor) of less than 0.30) considerably reduced the return velocity of the anvil and thus further mitigated the dislodging of a fastener from the collation. The second unexpected advantage that occurred when limiting the amount of overlap was a substantial increase in the apparatus safety. That is, by, limiting the overlap it was discovered that in the event of a jam of an apparatus, the anvil 22 and/or piston 1 will have released all or nearly all of its cyclic stored potential energy thereby limiting the hazard to the operator when the jam is cleared.

It is to be understood for purposes of this disclosure that the cyclic stored potential energy refers to the differential in two energy levels described as F delta x, where F is the force on the gas spring piston and x is the displacement between an initial (or de-energized) state and a compressed state. In another embodiment, an apparatus is provided that comprises the gas spring 100 described above as well as the other elements mentioned above that may be necessary and/or advantageous to drive, strike or impact objects.

In an embodiment and as shown in FIGS. 3 and 6, the drive mechanism of such an apparatus engages gas spring 100 and actuates the piston 1 of the gas spring 100 by pushing the piston 1 against a pusher plate 12 to store potential energy within the gas spring. In an embodiment, the initial pressure (before the drive mechanism actuates the piston) within the gas spring 100 is at least 200 psia. The configuration and design of the gas spring 100 may be such that the pressure increase during the piston movement is less than 30% of the initial pressure, thus yielding a more constant torque to the motor that improves the motor efficiency. In a still further embodiment, the gas spring 100 has a safety vent or safety valve 23 which releases as a result of internal pressure reaching at least 150% of the pressure level at the initial charge of the spring. In another embodiment, the drive mechanism engages the gas spring 100 and actuates the gas spring 100 by pushing it against the pusher plate 12 or by otherwise compressing the gas spring 100 to increase the stored potential energy within the gas spring 100. In an embodiment, the drive mechanism thereafter disengages the gas spring 100, allowing the stored potential energy to act on the pusher plate 12 and drive the anvil 22 away from the pusher plate 12 and thus provide an impact. The drive mechanism is configured to prevent further engagement until after the gas spring 100 and/or anvil 22 has returned to an approximate starting position. The drive mechanism may thereafter again act on the gas spring 100 to again store potential energy within the gas spring 100 and may thereafter again temporarily cease to act on the gas spring 100 to allow potential energy to instead act on the piston that has been pushing against the pusher plate 12 (or which gas spring 100 has been compressed) to launch the gas spring 100 and/or anvil 22. The drive mechanism can be configured to allow for continuous impacting, by way of a cam (not shown) or a rack and pinion, (as shown in FIG. 3 for example), to provide for such continuous impacting. In a preferred embodiment, the stroke of the piston 1 is less than the stroke of the anvil 22.

In an embodiment, the anvil assembly 16 is operatively coupled to the gas spring, such as to the piston 1 (as shown in an exemplary embodiment in FIG. 5) or the anvil 22 is coupled to the nose portion 1b of the gas spring (as shown in an exemplary embodiment in FIG. 6) such that when the drive mechanism is released, the force from the piston 1 of the gas spring is imparted onto the anvil causing the anvil move in a direction away from the pusher plate or the gas spring. The anvil transmits the force of the impact to an impact target, such as a post, nail, rivet, fastener and the like. It was discovered during the course of development that the ratio of the thrown mass (such as the anvil or anvil assembly for example) to the moving mass within the gas spring (the piston) was important to the efficiency and longevity of this embodiment. It is preferred to have the thrown mass (which in an exemplary embodiment is the anvil assembly) greater than 50% of the total moving mass (which is the anvil assembly+the gas spring moving mass), and more preferable, to have the anvil assembly mass be at least 60% of the total moving mass. This allows for increased efficiency in transferring the potential energy into driving energy on the object or substrate and improves the longevity of the device. In an embodiment, the mass of the anvil 22 is two to ten times the mass of the gas spring piston 1. In an embodiment, the gas spring piston 1 has a mass of less than 30 grams and the anvil has a mass of at least 160 grams. In an embodiment, the gas spring piston 1 is hollowed out to lighten its mass and further may be constructed of lightweight materials such as hard anodized aluminum, composites, plastics, or the like. The anvil 22 may be operatively coupled to a guide, shaft, or other structure that limits and/or directs its range of motion as part of an assembly 16.

At least one bumper 5 may be disposed on the apparatus for absorbing a portion of the force of impact of the piston 1 within the gas spring 3 and/or against the anvil assembly 16, to reduce wear and tear on the components of the apparatus. The at least one bumper 5 may be of an elastic material, and may be disposed on the apparatus at any position where it is capable of absorbing a portion of the force of impact by the piston 1 or the anvil. In a further embodiment, at least one sensor 24 is provided, which at least one sensor may be used to determine at least one location of the gas spring and/or anvil 22 and/or anvil assembly 16.

The gas spring and/or anvil assembly 16 may further comprise a return element or mechanism 13, which biases the anvil 22 in a direction opposite of the fastener drive as shown in FIGS. 4, 6, and 7. In an embodiment, the return mechanism 13 is a spring or elastomer. During and after or in connection with the anvil 22 impacting a surface and/or driving an object, the return element 13 imparts a force on the anvil 22 to cause the anvil 22 to return to a position where it may again be operatively acted upon by the gas spring and or drive mechanism. In the embodiment where the return mechanism 13 is an elastomer, the elastomer may be disposed such that motion of the anvil 22 toward an impact target causes the elastomer to stretch or increase in length and after the anvil 22 has reached the end of its driven stroke, the stretched elastomer causes the anvil to return to an initial position.

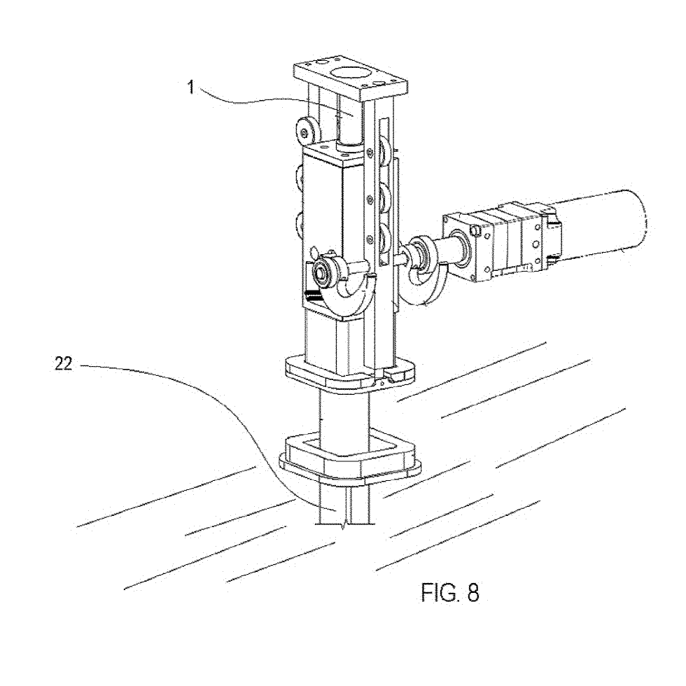

An alternate embodiment for returning the anvil assembly and anvil to a cycle start position is to use the positioning of the apparatus to bring the anvil to an approximate starting position, as shown in FIG. 8. This embodiment has the advantage in that no return mechanism would be required to reset the mechanism, thus eliminating an item that may otherwise wear during use of the apparatus.

In such an embodiment, the impact target is utilized to move (push) the anvil into position against the pusher plate. A stop within the apparatus (disposed on or in the guide or shaft that constrains the anvil and/or anvil assembly, for example) may also be provided for preventing the impact target or striker from moving with the anvil as it is energized. In this position the impact target would rest inside or against the striker and the striker would rest against a stop, preventing the impact target from moving up with the anvil when the piston is being actuated to store potential energy within the gas spring. This allows the anvil to still release from the pusher plate and re-engage the striker during the drive portion of the operational cycle.

In another embodiment, the apparatus further comprises a power adjustment mechanism for adjusting the force of impact by the apparatus. In an embodiment, the power adjustment mechanism comprises adjustable positioning of the pusher plate with respect to the gas spring and/or anvil and/or anvil assembly. By changing such positioning of the pusher plate, the amount of compression of the gas spring can be adjusted, and force of impact is consequently affected. The position of the pusher plate may be adjusted by way of a screw that may be actuated to reposition the pusher plate for example.

The present disclosure offers the following advantages: the high-pressure gas spring is capable of generating a relatively high amount of force in a small amount of space such that the size of the apparatus may be smaller than other impacting apparatuses. Furthermore, because the gas spring operates at a reduced piston size and stroke, efficiency is increased as friction and free air displacement are reduced. Further, because of the relatively small increase from the initial pressure in the gas spring to the maximum pressure, the motor of the apparatus is not significantly overworked or overtorqued, thus leading to a longer useful life of the apparatus. Moreover, the apparatus disclosed herein has an improved safety profile over prior art impacting devices. For example, the apparatus disclosed herein has a significantly reduced recoil force as opposed to the prior art. This was an unexpected discovery as the anvil of the present disclosure is a free traveling mass and, as such, during the course of the driving of an object or striking a substrate, therefore does not put a reactionary force on the operator. In contrast, with conventional tools, air pressure on the piston and anvil assembly acts during the entire drive and at the end of the stroke can result in significant recoil to the operator in the event the fastener jams in the substrate.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A gas spring for an impacting device, wherein said gas spring comprising
A cylinder, said cylinder comprising at least one gas and a pressurized enclosure,
A piston, said piston partially disposed within said cylinder, said piston capable of moving linearly with respect to cylinder,
A bumper,
At least one seal,
An anvil for delivery of an impact,
wherein during an operational cycle of said gas spring, said piston is moved to an energized position and thereafter released from such energized position,
wherein said gas pressure within said cylinder is at least 200 psi,
wherein the displacement of the piston is less than the displacement of the anvil and
wherein the bumper absorbs at least a portion of the piston energy as the piston moves from an energized to a de-energized position.

2. The gas spring of claim 1, wherein the piston volume is less than 80% of the swept or solid volume of said piston.

3. The gas spring of claim 1, wherein said at least one seal is a one-way seal allowing for the gas spring to be pressurized by differential pressure across the seal.

4. The gas spring of claim 1, wherein the gas of the cylinder comprises at least 90% one of nitrogen or an inert gas.

5. The gas spring of claim 1, said gas spring further comprises one of an elastomer or spring to bias the anvil towards an energized position.

6. The gas spring of claim 1 in which the anvil drives a fastener and in which the anvil overlaps the fastener by at least 0.1 inch but less than 1 inch when the gas spring is in a de-energized position.

7. The gas spring of claim 1 further comprising a safety valve rated to vent the chamber pressure at a minimum of 150% of the initial chamber pressure.

8. The gas spring piston of claim 1 further comprising a taper fit that engages a portion of the gas spring or anvil in at least one position of the operational cycle

9. The gas spring of claim 1 in which a minimum of 0.1 cc of lubricant is dispersed into the cylinder prior to pressurization.

10. The gas spring of claim 1 in which a sensor is used to determine at least one location of the gas spring and/or anvil.

11. A gas spring for an electric driven impactor wherein the gas spring comprises
A chamber, said chamber comprising at least one pressurized gas, a piston, said piston partially disposed within said chamber, said piston capable of moving linearly with respect to the chamber, and said piston comprising a flange, a volume and a swept volume,
A bumper,
At least one seal, and
An anvil for delivering an impact,
wherein said pressure within said cylinder is at least 200 psia, and wherein the piston volume is less than 80% of the swept volume.
and wherein the area of said piston flange is less than 90% of the cross sectional area of the chamber.

12. The gas spring of claim 11, wherein said at least one seal is a one-way seal allowing for the gas spring to be pressurized by differential pressure across the seal.

13. The gas spring of claim 11, wherein the gas of the cylinder comprises at least 90% one of nitrogen or an inert gas.

14. The gas spring of claim 11, said gas spring further comprises one of an elastomer or spring operatively coupled to at least one of the piston, the cylinder, and the anvil.

15. The gas spring of claim 11 in which a sensor is used to determine at least one location of the gas spring and or anvil.

16. A gas spring for an electric driven impacting device where-in the gas spring comprises
A cylinder, said cylinder comprising at least one gas and a pressurized enclosure,
A piston, said piston partially disposed within said cylinder, said piston capable of moving linearly with respect to the altitude of the cylinder, and said piston comprising a flange, a volume and a swept volume,
A bumper,
At least one seal,
An anvil operatively coupled to at least one of said cylinder and said piston for delivering an impact,
wherein during an impact cycle of the gas spring the piston is forced to an energized position and released from such energized position, and
wherein the maximum kinetic energy of the piston never exceeds 30% of the cyclic potential energy of the gas spring as it moves from an energized position to a de-energized position.

17. The gas spring of claim 16, further comprising a bumper wherein the bumper absorbs at least a portion of the piston energy as the piston moves from an energized to a de-energized position.

18. The gas spring of claim 16, wherein the gas of the cylinder comprises at least 90% one of nitrogen or an inert gas.

19. The gas spring of claim 16, said gas spring further comprises one of an elastomer or spring that biases said anvil to an energized state

20. The gas spring of claim 16, wherein said piston of said gas spring comprises a flange, and wherein the area of said flange is less than 90% of the cross sectional area of the gas spring cylinder.
